(19) United States
(12) Patent Application Publication
(10) Pub. No.: US 2015/0133102 A1
(43) Pub. Date: May 14, 2015

(54) TRIGGERING OF DIRECT DISCOVERY SIGNALS

(71) Applicant: Telefonaktiebolaget L M Ericsson (publ), Stockholm (SE)

(72) Inventor: Stefano Sorrentino, Solna (SE)

(21) Appl. No.: 14/536,835

(22) Filed: Nov. 10, 2014

Related U.S. Application Data
(60) Provisional application No. 61/902,238, filed on Nov. 10, 2013.

(51) Int. Cl. H04W 8/00

(52) U.S. Cl. CPC H04W 8/005
USPC 455/418

(57) ABSTRACT

Embodiments of systems and methods enabling Device-to-Device (D2D) discovery in a cellular network assisted D2D communication system are disclosed. In some embodiments, a method of operation of a wireless device comprises receiving at least one trigger for D2D discovery from a controlling node of the wireless device in a cellular communications network. The method of operation of the wireless device further comprises transmitting multiple transmission instances of a discovery signal of the wireless device for a D2D discovery event in response to the at least one trigger using resources selected from a group consisting of: different time resources, different frequency resources, different code resources, different time and frequency resources, different time and code resources, different frequency and code resources, and different time, frequency, and code resources. In this manner, detection of the discovery signal by other proximate wireless devices is substantially improved.

### RELATED APPLICATIONS

This application claims the benefit of provisional patent application Ser. No. 61/902,238, filed Nov. 10, 2013, the disclosure of which is hereby incorporated herein by reference in its entirety.

### FIELD OF THE DISCLOSURE

The present disclosure pertains to triggering direct discovery signals and, in particular to triggering direct discovery signals for Device-to-Device (D2D) applications.

### BACKGROUND

Device-to-Device (D2D) communication is a component of existing wireless technologies, including ad hoc and cellular networks. Examples of wireless systems that utilize D2D communication include Bluetooth® systems and systems that operate according to several variants of the IEEE 802.11 standards suite such as WiFi Direct. These systems operate in an unlicensed spectrum.

D2D communications as an underlay to cellular networks can be used to take advantage of the proximity of communicating devices and, at the same time, to allow devices to operate in a controlled interference environment. Typically, it is suggested that such D2D communication shares the same spectrum as the cellular system, for example by reserving some of the cellular uplink resources for D2D purposes. Allocating dedicated spectrum for D2D purposes is a less likely alternative as spectrum is a scarce resource and (dynamic) sharing between D2D services and cellular services is more flexible and provides higher spectrum efficiency.

One key aspect of D2D communications as an underlay to cellular networks, which is referred to herein as cellular network assisted D2D communication, is direct, or D2D, device discovery. As such, there is a need for systems and methods for D2D discovery in a cellular network assisted D2D communication system.

### SUMMARY

Embodiments of systems and methods enabling Device-to-Device (D2D) discovery in a cellular network assisted D2D communication system are disclosed. In some embodiments, a method of operation of a wireless device to enable D2D discovery comprises receiving at least one trigger for D2D discovery from a controlling node of the wireless device in a cellular communications network. The method of operation of the wireless device further comprises transmitting multiple transmission instances of a discovery signal of the wireless device for a D2D discovery event in response to the at least one trigger using resources selected from a group consisting of: different time resources, different frequency resources, different code resources, different time and frequency resources, different time and code resources, different frequency and code resources, and different time, frequency, and code resources. By transmitting the multiple transmission instances of the discovery signal using different resources, detection of the discovery signal by other proximate wireless devices is substantially improved.

In some embodiments, the resources used for transmitting the multiple transmission instances of the discovery signal comprise different time resources. In other embodiments, the resources used for transmitting the multiple transmission instances of the discovery signal comprise different frequency resources. In other embodiments, the resources used for transmitting the multiple transmission instances of the discovery signal comprise different code resources. In other embodiments, the resources used for transmitting the multiple transmission instances of the discovery signal comprise different time and frequency resources. In other embodiments, the resources used for transmitting the multiple transmission instances of the discovery signal comprise different time and code resources. In other embodiments, the resources used for transmitting the multiple transmission instances of the discovery signal comprise different frequency and code resources. In other embodiments, the resources used for transmitting the multiple transmission instances of the discovery signal comprise different time, frequency, and code resources.

In some embodiments, the at least one trigger comprises an individual trigger for each of the multiple transmission instances of the discovery signal.

In other embodiments, the at least one trigger comprises a single common trigger for all of the multiple transmission instances of the discovery signal. Further, in some embodiments, the single common trigger indicates a discovery resource pattern for the multiple transmission instances of the discovery signal. The discovery resource pattern is indicative of a set of resources comprising the resources used for transmission of the multiple transmission instances of the discovery signal. In some embodiments, the single common trigger is further indicative of a length of the discovery resource pattern.

In some embodiments, the resources used for transmitting the multiple transmission instances of the discovery signal are defined by a discovery resource pattern. In some embodiments, the discovery resource pattern is assigned to the wireless device by the controlling node.

In some embodiments, the discovery resource pattern is wireless device specific. In other embodiments, the discovery resource pattern is cell-specific.

In some embodiments, the discovery resource pattern is signaled from the controlling node to the wireless device. In other embodiments, the discovery resource pattern is predefined.

In some embodiments, the discovery resource pattern is assigned to multiple wireless devices, including the wireless device, such that a monitoring wireless device is enabled to monitor for discovery signals for all wireless devices under the control of the same controlling node at least once within a length of a period of the discovery resource pattern.

In some embodiments, the multiple transmission instances of the discovery signal cover at least a full cycle of the discovery resource pattern.

Embodiments of a wireless device enabling D2D discovery are also disclosed. In some embodiments, the wireless device comprises a transceiver, at least one processor, and memory containing software executable by the at least one processor whereby the wireless device is operative to operate according to any of the methods disclosed herein.

Embodiments of a method of operation of a network node of a cellular communications network to trigger D2D discovery are also disclosed herein. In some embodiments, the method of operation of the network node comprises transmitting at least one trigger for D2D discovery to a wireless device in the cellular communications network. The at least one trigger causes the wireless device to transmit multiple instances of a discovery signal for a D2D discovery event using resources selected from a group consisting of: different time resources, different frequency resources, different code resources, different time and frequency resources, different time and code resources, different frequency and code resources, and different time, frequency, and code resources.

In some embodiments, the at least one trigger causes the wireless device to transmit the multiple instances of the discovery signal using different time resources. In other embodiments, the at least one trigger causes the wireless device to transmit the multiple instances of the discovery signal using different frequency resources. In other embodiments, the at least one trigger causes the wireless device to transmit the multiple instances of the discovery signal using different code resources. In other embodiments, the at least one trigger causes the wireless device to transmit the multiple instances of the discovery signal using different time and frequency resources. In other embodiments, the at least one trigger causes the wireless device to transmit the multiple instances of the discovery signal using different time and code resources. In other embodiments, the at least one trigger causes the wireless device to transmit the multiple instances of the discovery signal using different frequency and code resources. In other embodiments, the at least one trigger causes the wireless device to transmit the multiple instances of the discovery signal using different time, frequency, and code resources.

In some embodiments, transmitting the at least one trigger comprises transmitting an individual trigger for each of the multiple transmission instances of the discovery signal.

In other embodiments, transmitting the at least one trigger comprises transmitting a single common trigger for all of the multiple transmission instances of the discovery signal. Further, in some embodiments, the single common trigger indicates a discovery resource pattern for the multiple transmission instances of the discovery signal. The discovery resource pattern is indicative of a set of resources comprising the resources used by the wireless device to transmit the multiple instances of the discovery signal for the D2D discovery event. Further, in some embodiments, the single common trigger is further indicative of a length of the discovery resource pattern.

In some embodiments, the discovery resource pattern is assigned to the wireless device.

In some embodiments, the discovery resource pattern is wireless device specific. In other embodiments, the discovery resource pattern is cell-specific.

In some embodiments, the discovery resource pattern is signaled to the wireless device. In other embodiments the discovery resource pattern is predefined.

In some embodiments, the discovery resource pattern is assigned to multiple wireless devices, including the wireless device, such that a monitoring wireless device is enabled to monitor for discovery signals for all wireless devices under the control of the same controlling node at least once within a length of a period of the discovery resource pattern.

In some embodiments, the multiple transmission instances of the discovery signal cover at least a full cycle of the discovery resource pattern.

Embodiments of a network node are also disclosed. In some embodiments, the network node comprises a radio unit, at least one processor, and memory containing software executable by the at least one processor whereby the network node is operative to operate according to any of the embodiments of the method of operation of a network node disclosed herein.

Those skilled in the art will appreciate the scope of the present disclosure and realize additional aspects thereof after reading the following detailed description of the embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an example Frequency Division Multiplexing (FDM) mapping of discovery signals in select subframes;

FIG. 2 illustrates one example of a discovery resource pattern that is utilized together with multiple Device-to-Device (D2D) discovery triggers to trigger transmission of multiple instances of a D2D discovery signal by a wireless device according to some embodiments of the present disclosure;

FIG. 3 illustrates one example of a discovery resource pattern that is utilized together with a single D2D discovery trigger to trigger transmission of multiple instances of a D2D discovery signal by a wireless device according to some embodiments of the present disclosure;

FIG. 4 illustrates one example of a cellular communications network that enables D2D discovery according to some embodiments of the present disclosure;

FIG. 5 illustrates the operation of the cellular communications network of FIG. 4 to enable D2D discovery according to some embodiments of the present disclosure;

FIG. 6 illustrates the operation of the cellular communications network of FIG. 4 to enable D2D discovery using individual triggers for multiple instances of the discovery signal according to some embodiments of the present disclosure;

FIG. 7 illustrates the operation of the cellular communications network of FIG. 4 to enable D2D discovery using a single, common D2D discovery trigger according to some embodiments of the present disclosure;

FIG. 8 is a block diagram of a base station according to some embodiments of the present disclosure;

FIG. 9 is a block diagram of a base station according to other embodiments of the present disclosure;

FIG. 10 is a block diagram of a wireless device according to some embodiments of the present disclosure; and

FIG. 11 is a block diagram of a wireless device according to other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Systems and methods for direct Device-to-Device (D2D) discovery in a cellular communications network are disclosed. Before describing embodiments of the present disclosure, a discussion of D2D discovery, particularly in a cellular network assisted D2D communication system, and some associated problems is beneficial. Devices that want to communicate via a D2D connection, or even just discover each other, typically transmit various forms of control signaling. One example of such control signaling is the so-called discovery signal. A discovery signal may possibly include a full message, but at least carries some form of identity and is transmitted by a device that wants to be discoverable by other devices. Devices can scan for discovery signals from other devices. Once a device has detected the discovery signal of another device, the device can take an appropriate action, such as, for example, initiate a D2D connection setup with the device transmitting the discovery signal.

Multiple discovery signals from different devices can be multiplexed on the same radio resources in a combination of Time Division Multiplexing (TDM), Frequency Division Multiplexing (FDM), and possibly Code Division Multiplexing (CDM). Discovery signals can be multiplexed on specific subframes occurring at known (or signaled) positions in the radio frame. Such subframes carrying at least discovery signals are referred to herein as discovery subframes.

The transmission of a discovery signal by a device in a cellular network assisted D2D communication system (particularly one that uses the same resources for both D2D communication and normal cellular communication) is scheduled by the cellular network. In 3^{rd} Generation Partnership Project (3GPP), the following options for scheduling discovery signals have been considered:
Type 1: a discovery procedure where resources for discovery signal transmission are allocated on a non-User Equipment (UE) specific basis. Here, resources can be for all UEs or for a group of UEs.
Type 2: a discovery procedure where resources for discovery signal transmission are allocated on a per UE specific basis.
Type 2A: resources are allocated for each specific transmission instance of discovery signals.
Type 2B: resources are semi-persistently allocated for discovery signal transmission.
   While Type 1 and Type 2 discovery were defined by 3GPP, so far, there is no agreement in 3GPP about when to use each discovery type.

For various reasons, a receiver may not be able to detect a discovery signal transmitted by a peer device in proximity. Such reasons include, e.g.:
Half duplex constraints: If a wireless device is simultaneously transmitting any signal on the same carrier, the wireless device is not able to detect incoming signals.
In-band emissions: Strong discovery messages from wireless devices may generate interference on adjacent portions of the spectrum that mask discovery signals.
Dynamic range limitations: Strong discovery signals may drive the Amplitude Gain Control (AGC) setting at the receiver and prevent detection of weaker signals because of limitations in the dynamic range of the wireless device.

For Type 1 and Type 2B discovery, occasionally missing a discovery signal might not be problematic because such signals are retransmitted periodically. However, for Type 2A discovery where each instance is scheduled independently, a wireless device in proximity may not be detected at all if its transmission instance is missed. Since in general idle wireless devices are able to participate in discovery, the cellular network is unaware of which wireless devices succeed in discovery, and the cellular network does not have information for taking actions such as rescheduling a discovery signal after failed detection.

Embodiments of systems and methods for direct D2D discovery that address, at least in some embodiments, the aforementioned problems are disclosed herein. In general, the commonality among the embodiments disclosed herein is that a train of discovery signals is transmitted to achieve a single discovery event. This train of discovery signals is referred to herein as multiple transmission instances (which are sometimes simply referred to herein as multiple instances) of a discovery signal. Other embodiments propose ways to increase probability that at least one of such signals (i.e., at least one of the transmission instances) is correctly detected by all wireless devices (e.g., UEs) in proximity to the transmitting wireless device (e.g., UE) and to limit the signaling overhead.

In some embodiments, a network element (also referred to herein as a network node), such as that found as part of a radio base station, transmits multiple D2D discovery triggers. The multiple D2D discovery triggers schedule a wireless device (e.g., a UE) to transmit multiple instances of a discovery signal. The multiple D2D discovery triggers can, in some embodiments, be conveyed over a control channel from the network element to the wireless device. In some embodiments, the transmissions of the multiple instances of the discovery signal, or message, from the wireless device are configured to achieve sufficient randomization in terms of interference and/or time and/or frequency resources. In some embodiments, the network element may be configured to schedule a number of transmission instances sufficient to cover at least a full cycle of a discovery resource pattern.

In other embodiments, a single D2D discovery trigger is transmitted by the network element. The single D2D discovery trigger operates to trigger multiple discovery signals (or a sequence of discovery signals) transmitted by the wireless device and associated with different time and/or frequency and/or code resources. In other words, the single D2D discovery trigger operates to trigger transmission of multiple instances of the discovery signal by the wireless device using different time and/or frequency and/or code resources.

Embodiments disclosed herein provide solutions for reliable detection of discovery messages individually triggered by the cellular network.

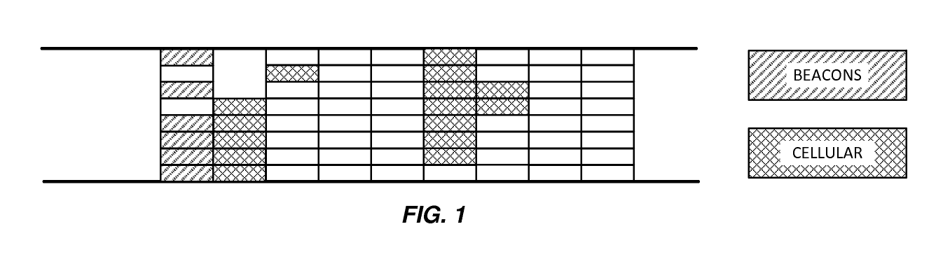

In much of the discussion herein, FDM mapping of the discovery signals, or beacons, in select subframes is assumed (in a non-limiting way) as shown in FIG. 1. However, most of the principles and techniques described herein may be applied to different beacon multiplexing techniques, such as CDM and TDM.

All wireless devices (e.g., UEs) camping on the same cell or Synchronization Cluster Head (SCH) share a common synchronization reference provided by the base station (e.g., enhanced, or evolved, Node B (eNB)) or by a wireless device (e.g., UE) acting as a synchronization reference (e.g., the SCH).

Each wireless device (e.g., UE) may be assigned a predefined or wireless device generated pattern of resources (referred to herein as a D2D discovery resource or simply discovery resource pattern) for potential transmission of discovery signals, or beacons. For Type 2A discovery, a controlling node (typically, but not necessarily, a base station (e.g., an eNB)) schedules the wireless device to transmit a discovery signal by conveying such scheduling trigger over a control channel from the control node to the wireless device.

The discovery resource pattern may be wireless device specific or cell-specific, and the discovery resource pattern defines or otherwise indicates a set of time and/or frequency and/or code resources. Additionally, the discovery resource pattern might, in some embodiments, carry information about transmit format and coding (e.g., redundancy version) associated with the discovery signals. Discovery resource patterns may have an associated periodicity, i.e., they may repeat themselves after one period.

In some embodiments, whenever the cellular network (e.g., the base station) intends to make a certain wireless device discoverable, instead of transmitting a single trigger as proposed in Type 2A discovery, the cellular network transmits multiple individual triggers to the wireless device. The cellular network transmits the individual triggers to the wireless device in such a way that the transmissions of multiple instances of the discovery message/signal achieve sufficient randomization in terms of interference and/or time and/or frequency resources to enable detection by another wireless device.

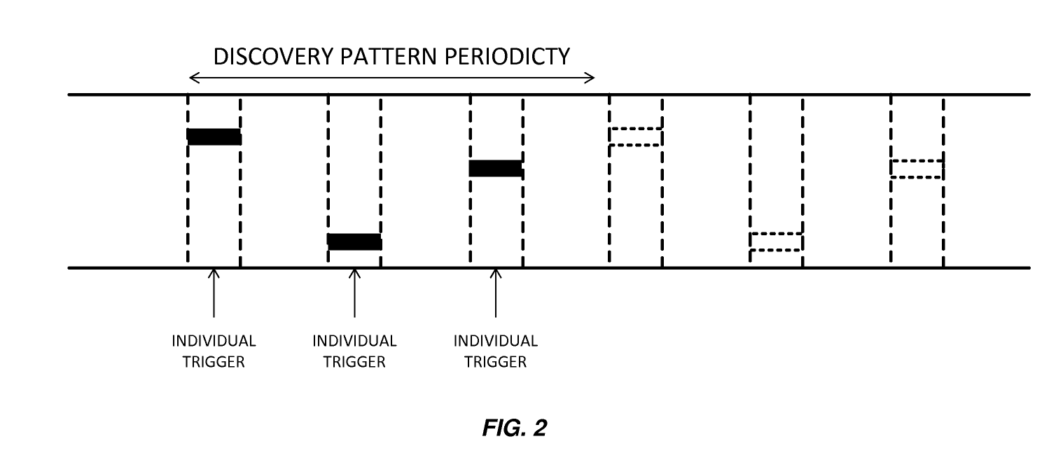

If a preconfigured discovery resource pattern is defined, in one example the controlling node schedules a number of transmission instances sufficient to cover at least a full cycle of the discovery resource pattern as illustrated in, as a non-limiting example, FIG. 2. In FIG. 2, the solid boxes indicate discovery messages transmitted (by a certain wireless device). The dotted boxes indicate the resources corresponding to the predefined resource pattern. The horizontal axis is time, while vertical axis is frequency. Discovery resource patterns may be designed and assigned to multiple wireless devices in such a way that each wireless device monitors the discovery messages from any other wireless device under control of a given same controlling node at least once, within the length of the period of the discovery resource pattern.

In some examples, multiple triggers are multiplexed in a single control message from the controlling node.

In other embodiments, the cellular network (e.g., a base station) transmits a single trigger for Type 2A discovery. This single trigger operates to trigger a sequence of discovery signals (i.e., multiple instances of a discovery signal) associated to at least different time and/or frequency and/or code resources.

In some embodiments, the trigger is characterized by indication of a discovery resource pattern and, in some embodiments, possibly an indication of the length of such discovery resource pattern.

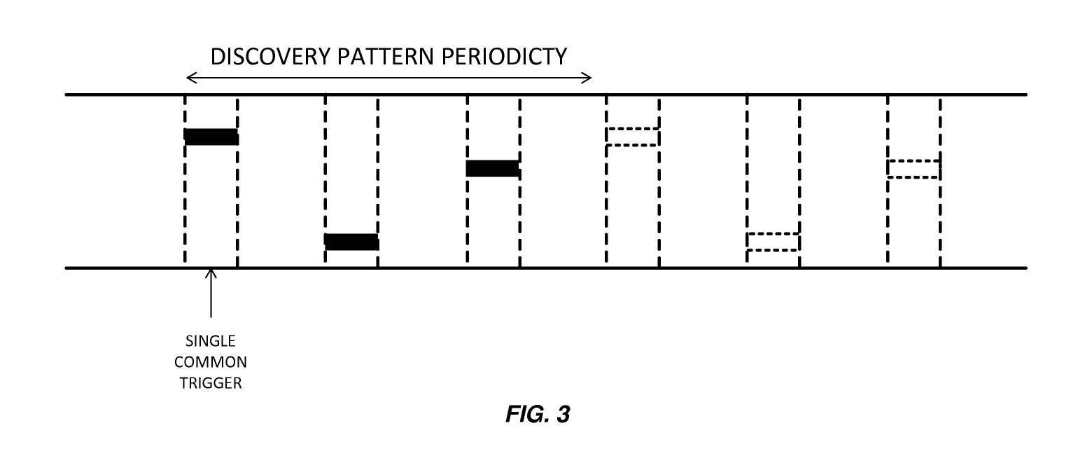

In one example, the indication of the length is not included in the trigger message as it is implicitly assumed that the wireless device should transmit a full cycle of resources according to a predefined pattern as illustrated in, as a non-limiting example, FIG. 3. In FIG. 3, the solid boxes indicate discovery messages transmitted (by a certain wireless device). The dotted boxes indicate the resources corresponding to the predefined resource pattern. The horizontal axis is time, while vertical axis is frequency. Such a discovery resource pattern may be indicated by signaling from a controlling node of the wireless device, or it could be predefined or pre-configured.

Compared to embodiment one, embodiment two reduces control signalling, since a single trigger achieves transmission of multiple discovery messages (i.e., multiple instances of a discovery signal).

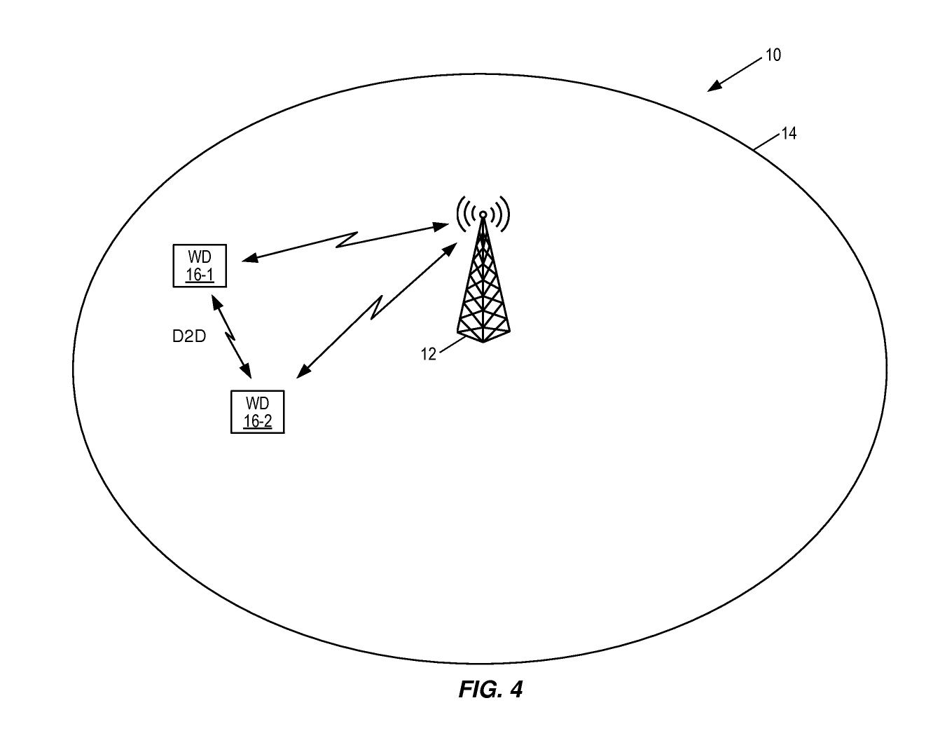

The embodiments described above are implemented in a cellular communications network. In this regard, FIG. 4 illustrates one example of a cellular communications network 10 that enables direct D2D discovery according to some embodiments of the present disclosure. In some embodiments, the cellular communications network 10 is a 3GPP Long Term Evolution (LTE) network and, as such, 3GPP LTE terminology is sometimes used herein. However, the concepts disclosed herein are not limited to 3GPP LTE and may be used in any suitable type of cellular network assisted D2D communication system. As illustrated, the cellular communications network 10 includes a base station 12 that serves a cell 14 of the cellular communications network 10. Wireless devices 16-1 and 16-2 (generally referred to herein collectively as wireless device 16 and individually as wireless device 16) are within the cell 14 (e.g., camped on the cell 14 in IDLE mode or connected to the cell 14 in CONNECTED mode). In 3GPP LTE, the base station 12 is referred to as an eNB, and may be either a macro cell eNB or a small cell eNB (e.g., a Home eNB (HeNB)). Similarly, in 3GPP LTE, the wireless devices 16-1 and 16-2 are referred to as UEs (e.g., mobile smart phones, tablet computers, Machine Type Communication (MTC) devices, etc.).

The wireless devices 16-1 and 16-2 participate in D2D communication. However, before D2D communication can occur, the wireless devices 16-1 and 16-2 must discover one another and set up a D2D connection. The embodiments disclosed herein enable the cellular communications network 10 (e.g., the base station 12) to schedule transmissions of D2D discovery signals by wireless devices, such as, for example, the wireless device 16-1. In particular, the cellular communications network 10 (e.g., the base station 12) triggers transmission of multiple instances of a discovery signal by the wireless device 16-1. The multiple instances of the discovery signal are transmitted by the wireless device 16-1 using different time resources, different frequency resources, different code resources, different time and frequency resources, different time and code resources, or different time, frequency, and code resources, depending on the particular implementation. By using different resources for the transmissions of the multiple instances of the discovery signal, the transmissions can be sufficiently randomized to enable detection of at least one of the instances of the discovery signal by other wireless devices, e.g., the wireless device 16-1, in proximity to the wireless device 16-1 with at least a reasonable degree of certainty (e.g., at least 90% of the time). In other words, by transmitting multiple instances of the discovery signal using different resources, the wireless device 16-2 is likely to detect at least one of the transmissions even if the wireless device 16-2 misses or is unable to detect the other transmissions.

Further, in some embodiments, the resources utilized for the transmission of the multiple instances of the discovery signal are defined by a discovery resource pattern. The discovery resource pattern may be wireless device specific or cell-specific. Further, the discovery resource pattern may be, e.g., predefined (e.g., by a standard) or pre-configured by the cellular communications network 10.

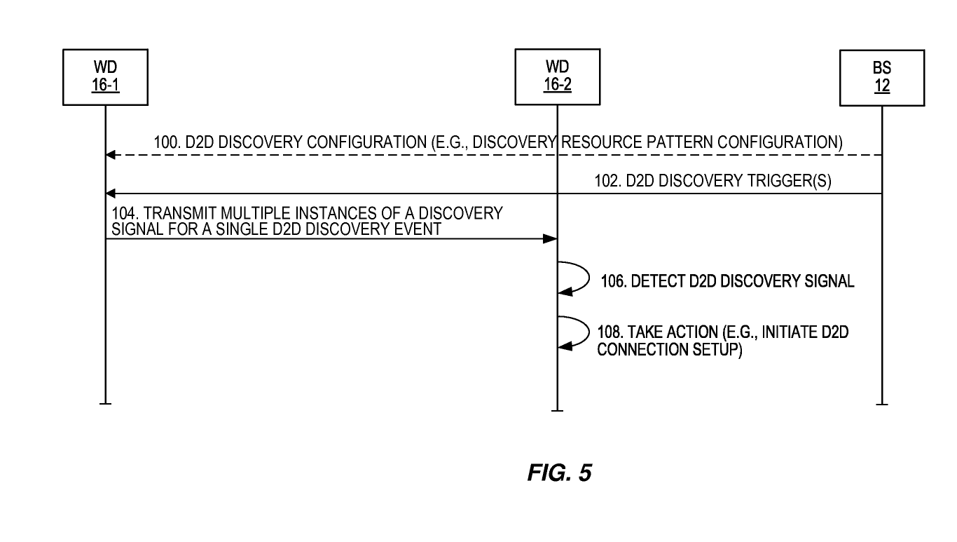

FIG. 5 illustrates the operation of the cellular communications network 10 of FIG. 4 to enable D2D discovery according to some embodiments of the present disclosure. As illustrated, in some embodiments, the base station 12 configures D2D discovery via, e.g., control signaling (step 100). Note that step 100 is optional and is not required in all embodiments. In particular, the base station 12 may configure a D2D discovery resource pattern to be used for transmission of multiple instances of a discovery signal by the wireless device 16-1. As used herein, a D2D discovery resource pattern, or simply discovery resource pattern, defines, or is otherwise indicative of, a set of time and/or frequency and/or code resources that can be used for transmission of a D2D discovery signal by the wireless device 16-1. For example, the base station 12 may configure the length or period of the resource pattern, the number of resources/transmission instances in a period of the discovery resource pattern, and/or the discovery resource pattern itself (e.g., subframe number(s), symbol period(s) within a subframe(s), resource block(s) in the frequency domain, resource element(s) within a resource block(s), etc.). In some embodiments, the discovery resource pattern is wireless device specific. In other embodiments, the discovery resource pattern is cell-specific. The discovery resource pattern may alternatively be predefined, e.g., by a standard.

The base station 12 transmits one or more D2D discovery triggers to the wireless device 16-1 (step 102). The D2D discovery trigger(s) is(are) also referred to herein simply as discovery trigger(s). In response to the D2D discovery trigger(s), the wireless device 16-1 transmits multiple instances of a discovery signal for a single D2D discovery event (step 104). As used herein, a D2D discovery event includes the transmission of multiple instances of the discovery signal by, e.g., the wireless device 16-1 such that detection of any one or more of the instances by, e.g., the wireless device 16-2 results in discovery of the wireless device 16-1 by the wireless device 16-2 for the same D2D discovery event. The multiple instances of the discovery signal are transmitted using different time and/or frequency and/or code resources, as discussed above.

In some embodiments, the multiple instances of the discovery signal are transmitted according to a D2D discovery pattern that defines a set of time and/or frequency and/or code resources that can be used for transmission of a D2D discovery signal by the wireless device 16-1. Again, in some embodiments, the discovery resource pattern is wireless device specific. In other embodiments, the discovery resource pattern is cell-specific. In some embodiments, the number of instances of the discovery signal that are triggered/scheduled by the cellular communications network 10 and therefore transmitted by the wireless device 16-1 is sufficient to cover at least a full cycle of the discovery resource pattern (e.g., as illustrated in FIG. 2). Also, the discovery pattern may be designed and assigned to multiple wireless devices, including the wireless device 16-1, in such a way that the wireless device 16-2 monitors for discovery signals from all other wireless devices 16 in the cell 14 at least once within the length of the period of the discovery resource pattern.

The wireless device 16-2 detects at least one of the instances of the discovery signal transmitted by the wireless device 16-1 (step 106). This detection may be performed using any suitable detection technique. For instance, the wireless device 16-2 may have knowledge of the resources that can potentially be used for transmission of D2D discovery signals (e.g., knowledge of the D2D discovery resource pattern(s) used in the cell 14) and monitor those resources for discovery signal transmissions. In response to detecting the discovery signal transmitted by the wireless device 16-1, the wireless device 16-2 takes an appropriate action (step 108). For example, the wireless device 16-2 may initiate setup of a D2D connection with the wireless device 16-1 using any suitable D2D connection setup procedure.

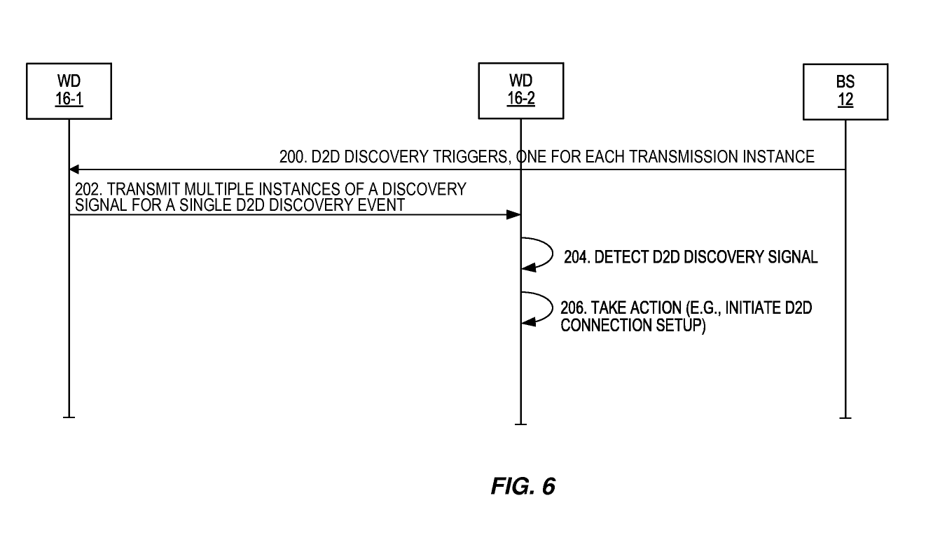

As discussed above, in some embodiments, the cellular communications network 10 (e.g., the base station 12) transmits an individual trigger for each of the multiple instances of the discovery signal. In this regard, FIG. 6 illustrates the operation of the cellular communications network 10 of FIG. 4 to enable D2D discovery according to some embodiments of the present disclosure in which individual triggers are provided for the multiple instances of the discovery signal. As illustrated, the base station 12 transmits D2D discovery triggers to the wireless device 16-1 including one trigger for each transmission instance of the discovery signal of the wireless device 16-1 (step 200). These discovery triggers are referred to herein as individual discovery triggers. Note that the discovery triggers may be provided in separate messages or multiplexed or otherwise combined into a single control message. The triggers are provided such that the transmissions of the instances of the discovery signal are triggered or scheduled in different time and/or frequency and/or code resources. Further, in some embodiments, the triggers are such that the resources in which the transmissions of the instances of the discovery signal are to occur are sufficiently randomized in terms of interference and/or time and/or frequency resources to enable detection of at least one of the instances of the discovery signal by other wireless devices (e.g., the wireless device 16-2) in proximity to the wireless device 16-1 with at least a reasonable degree of certainty (e.g., at least 90% of the time).

In some embodiments, the individual triggers are provided such that the transmissions of the multiple instances of the discovery signal by the wireless device 16-1 are triggered according to a D2D discovery pattern. The D2D discovery pattern defines a set of resources (e.g., time and/or frequency and/or code resources), as discussed above. The discovery pattern may be wireless device specific or cell-specific. In some embodiments, the base station 12 (or another controlling/network node) schedules a number of transmission instances of the discovery signal that is sufficient to cover at least one full cycle of the discovery resource pattern (see, for example, FIG. 2). Note that discovery resource patterns may be designed and assigned to multiple wireless devices in such a way that each wireless device (e.g., the wireless device 16-2) monitors for the discovery signals from any other wireless device under the control of the same controlling/network node (e.g., the same base station) at least once within the length of the period of the discovery resource pattern.

In response to the D2D discovery triggers, the wireless device 16-1 transmits multiple instances of a discovery signal for a single D2D discovery event (step 202). The multiple instances of the discovery signal are transmitted using different time and/or frequency and/or code resources, as indicated by the corresponding discovery triggers. In some embodiments, each of the discovery triggers indicates the corresponding time and/or frequency and/or code resource(s) to be used for transmission of the corresponding instance of the discovery signal.

The wireless device 16-2 detects at least one of the instances of the discovery signal transmitted by the wireless device 16-1 (step 204). This detection may be performed using any suitable detection technique. For instance, the wireless device 16-2 may have knowledge of the resources that can potentially be used for transmission of D2D discovery signals (e.g., knowledge of the D2D discovery resource pattern(s) used in the cell 14) and monitor those resources for discovery signal transmissions. The knowledge of the resources that can potentially be used for transmission of D2D discovery signals and therefore should be monitored by the wireless device 16-2 may be configured by the cellular communications network 10 (e.g., configured by the base station 12) or predefined (e.g., predefined by a standard). In response to detecting the discovery signal transmitted by the wireless device 16-1, the wireless device 16-2 takes an appropriate action (step 206). For example, the wireless device 16-2 may initiate setup of a D2D connection with the wireless device 16-1 using any suitable D2D connection setup procedure.

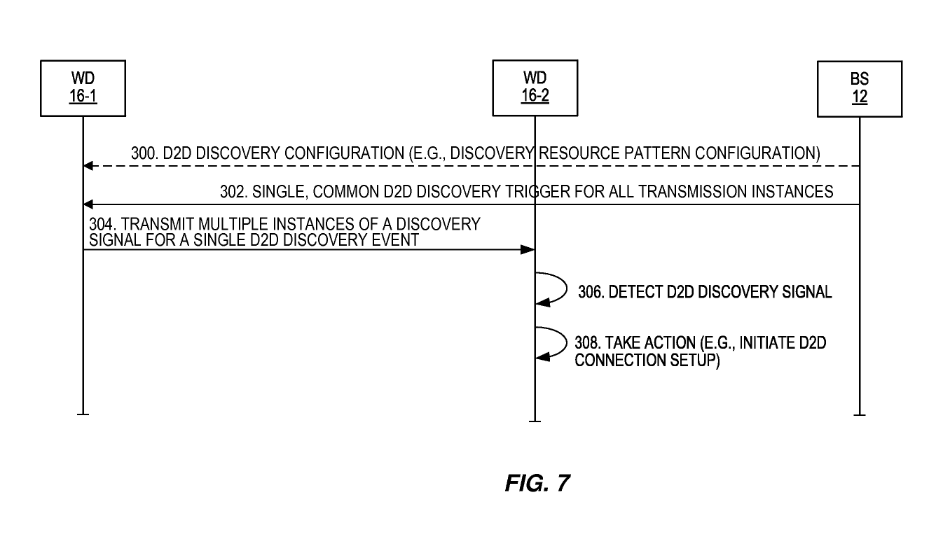

As discussed above, in other embodiments, a single, common D2D discovery trigger is used to trigger the transmission of the multiple instances of the discovery signal by the wireless device 16-1. In this regard, FIG. 7 illustrates the operation of the cellular communications network 10 of FIG. 4 to enable D2D discovery according to some embodiments of the present disclosure in which a single, common D2D discovery trigger is used. As illustrated, in some embodiments, the base station 12 configures D2D discovery via, e.g., control signaling (step 300). Note that step 300 is optional and is not required in all embodiments. In particular, the base station 12 may configure a D2D discovery resource pattern to be used by the wireless device 16-1. For example, the base station 12 may configure the length or period of the discovery resource pattern, the number of resources/transmission instances in a period of the discovery resource pattern, and/or the discovery resource pattern itself (e.g., subframe number(s), symbol period(s) within a subframe(s), resource block(s) in the frequency domain, resource element(s) within a resource block(s), etc.). In some embodiments, the discovery resource pattern is wireless device specific. In other embodiments, the discovery resource pattern is cell-specific. The discovery resource pattern may alternatively be predefined, e.g., by a standard. The base station 12 transmits a single, common D2D discovery trigger to the wireless device 16-1 (step 302). The discovery trigger is a single trigger that triggers or causes the wireless device 16-1 to transmit multiple instances of a discovery signal for a single D2D discovery event (step 304). The multiple instances of the discovery signal are transmitted using different time and/or frequency and/or code resources, as discussed above. The different resources may be indicated directly or indirectly by the discovery trigger. In some embodiments, the discovery trigger triggers the wireless device 16-1 to transmit the multiple instances of the discovery signal according to a predefined or pre-configured D2D discovery pattern. With respect to the discovery resource pattern, in some embodiments, the discovery trigger includes an indication of the discovery resource pattern and, possibly in some implementations, an indication of the length of the discovery resource pattern. In some embodiments, the number of instances of the discovery signal that are triggered/scheduled by the cellular communications network 10 and therefore transmitted by the wireless device 16-1 is sufficient to cover at least a full cycle of the discovery resource pattern (e.g., as illustrated in FIG. 3). Also, the discovery resource pattern may be designed and assigned to multiple wireless devices, including the wireless device 16-1, in such a way that the wireless device 16-2 monitors for discovery signals from all other wireless devices 16 in the cell 14 at least once within the length of the period of the discovery resource pattern.

The wireless device 16-2 detects at least one of the instances of the discovery signal transmitted by the wireless device 16-1 (step 306). This detection may be performed using any suitable detection technique. For instance, the wireless device 16-2 may have knowledge of the resources that can potentially be used for transmission of D2D discovery signals (e.g., knowledge of the D2D discovery resource pattern(s) used in the cell 14) and monitor those resources for discovery signal transmissions. In response to detecting the discovery signal transmitted by the wireless device 16-1, the wireless device 16-2 takes an appropriate action (step 308). For example, the wireless device 16-2 may initiate setup of a D2D connection with the wireless device 16-1 using any suitable D2D connection setup procedure.

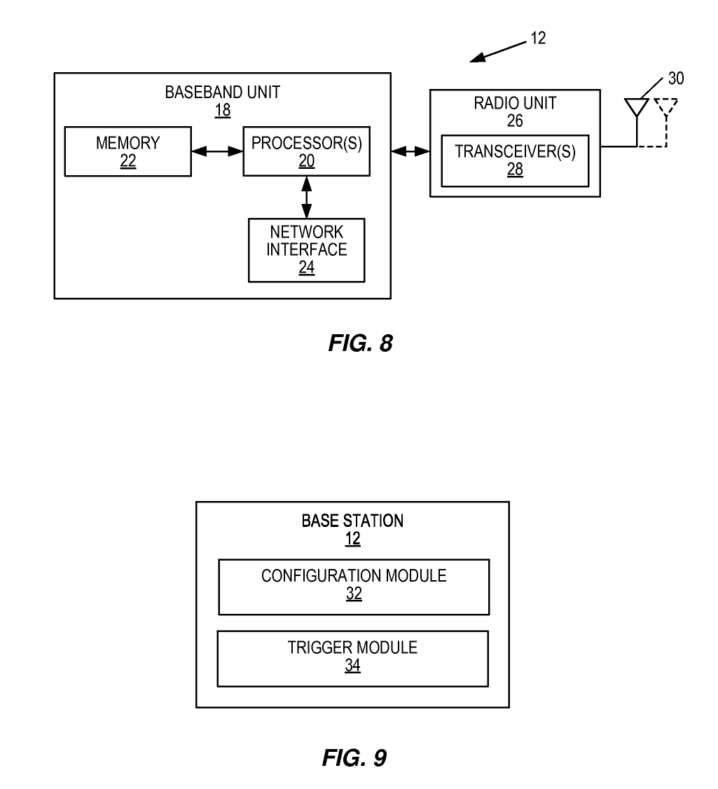

FIG. 8 is a block diagram of the base station 12 according to some embodiments of the present disclosure. Notably, some or all of the functionality of the base station 12 described herein may be implemented in another network node having components similar to those of FIG. 8 (e.g., at least one processor, memory, etc.). As illustrated, the base station 12 includes a baseband unit 18 including at least one processor 20 (e.g., Central Processing Unit(s) (CPU(s)), Application Specific Integrated Circuit(s) (ASIC(s)), Field-Programmable Gate Array(s) (FPGA(s)), or the like), memory 22, and a network interface 24 as well as a radio unit 26 including one or more transceivers 28 coupled to one or more antennas 30. In some embodiments, the functionality of the base station 12 is implemented in software and stored in the memory 22. This software is executable by the processor(s) 20, whereby the base station 12 operates according to any of the embodiments described herein.

In some embodiments, a computer program including instructions which, when executed by at least one processor circuit, causes the at least one processor to carry out the functionality of the base station 12 according to any of the embodiments described herein is provided. In one embodiment, a carrier containing the aforementioned computer program product is provided. The carrier is one of an electronic signal, an optical signal, a radio signal, or a computer readable storage medium (e.g., a non-transitory computer readable medium such as the memory 22).

FIG. 9 is a block diagram of the base station 12 according to other embodiments of the present disclosure. In this embodiment, the base station 12 includes a configuration module 32 and a trigger module 34, each of which is implemented in software. The configuration module 32 is optional and generally operates to, in some embodiments, configure, e.g., a D2D discovery resource pattern used by the wireless device 16-1. The trigger module 34 operates to transmit, via a transmitter (not shown) of the base station 12, one or more triggers that trigger transmission of multiple instances of a discovery signal from, e.g., the wireless device 16-1.

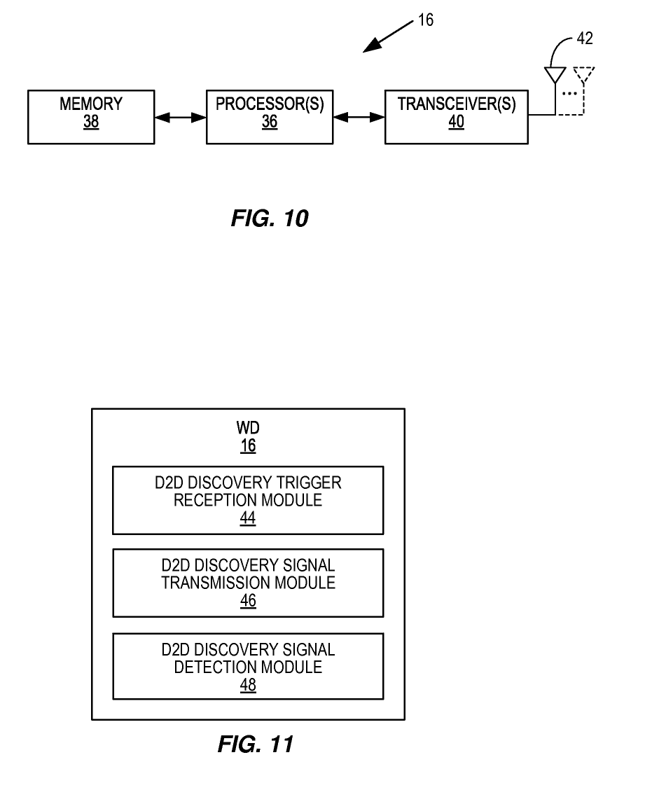

FIG. 10 is a block diagram of one of the wireless devices 16 according to some embodiments of the present disclosure. As illustrated, the wireless device 16 includes at least one processor 36 (e.g., CPU(s), ASIC(s), FPGA(s), or the like), memory 38, and one or more transceivers 40 coupled to at least one antenna 42. In some embodiments, the functionality of the wireless device 16 is implemented in software and stored in the memory 38. This software is executable by the processor(s) 36, whereby the wireless device 16 operates according to any of the embodiments described herein.

In some embodiments, a computer program including instructions which, when executed by at least one processor, causes the at least one processor to carry out the functionality of the wireless device 16 according to any of the embodiments described herein is provided. In one embodiment, a carrier containing the aforementioned computer program product is provided. The carrier is one of an electronic signal, an optical signal, a radio signal, or a computer readable storage medium (e.g., a non-transitory computer readable medium such as the memory 38).

FIG. 11 is a block diagram of the wireless device 16 according to other embodiments of the present disclosure. As illustrated, the wireless device 16 includes a D2D discovery trigger reception module 44, a D2D discovery signal transmission module 46, and a D2D discovery signal detection module 48, each of which is implemented in software. The D2D discovery trigger reception module 44 operates to receive, via a corresponding receiver (not shown) of the wireless device 16, at least one D2D discovery trigger, as described above. The D2D discovery signal transmission module 46 operates to transmit, via a corresponding transmitter (not shown) of the wireless device 16, multiple instances of a discovery signal in response to the reception of the D2D discovery trigger(s). Conversely, the D2D discovery signal detection module 48 operates to monitor for and detect D2D discovery signals transmitted by other wireless devices 16.

The following acronyms are used throughout this disclosure.
3GPP 3^{rd} Generation Partnership Project
AGC Amplitude Gain Control
ASIC Application Specific Integrated Circuit
CDM Code Division Multiplexing
CPU Central Processing Unit
D2D Device-to-Device
eNB Enhanced or Evolved Node B
FDM Frequency Division Multiplexing
FPGA Field-Programmable Gate Array
HeNB Home Enhanced or Evolved Node B
LTE Long Term Evolution
MTC Machine Type Communication
SCH Synchronization Cluster Head
TDM Time Division Multiplexing
UE User Equipment

Those skilled in the art will recognize improvements and modifications to the embodiments of the present disclosure. All such improvements and modifications are considered within the scope of the concepts disclosed herein and the claims that follow.

What is claimed is:

1. A method of operation of a wireless device to enable Device-to-Device, D2D, discovery, comprising:
receiving at least one trigger for D2D discovery from a controlling node of the wireless device in a cellular communications network; and
transmitting multiple transmission instances of a discovery signal of the wireless device for a D2D discovery event in response to the at least one trigger using resources selected from a group consisting of: different time resources, different frequency resources, different code resources, different time and frequency resources, different time and code resources, different frequency and code resources, and different time, frequency, and code resources.

2. The method of claim 1 wherein the resources used for transmitting the multiple transmission instances of the discovery signal comprise different time resources.

3. The method of claim 1 wherein the resources used for transmitting the multiple transmission instances of the discovery signal comprise different frequency resources.

4. The method of claim 1 wherein the resources used for transmitting the multiple transmission instances of the discovery signal comprise different code resources.

5. The method of claim 1 wherein the resources used for transmitting the multiple transmission instances of the discovery signal comprise different time and frequency resources.

6. The method of claim 1 wherein the resources used for transmitting the multiple transmission instances of the discovery signal comprise different time and code resources.

7. The method of claim 1 wherein the resources used for transmitting the multiple transmission instances of the discovery signal comprise different frequency and code resources.

8. The method of claim 1 wherein the resources used for transmitting the multiple transmission instances of the discovery signal comprise different time, frequency, and code resources.

9. The method of claim 1 wherein the at least one trigger comprises an individual trigger for each of the multiple transmission instances of the discovery signal.

10. The method of claim 1 wherein the at least one trigger comprises a single common trigger for all of the multiple transmission instances of the discovery signal.

11. The method of claim 10 wherein the single common trigger indicates a discovery resource pattern for the multiple transmission instances of the discovery signal, the discovery resource pattern being indicative of a set of resources comprising the resources used for transmission of the multiple transmission instances of the discovery signal.

12. The method of claim 11 wherein the discovery resource pattern indicated by the single common trigger is indicative of resources selected from a group consisting of: different time resources, different frequency resources, different code resources, different time and frequency resources, different time and code resources, different frequency and code resources, and different time, frequency, and code resources.

13. The method of claim 11 wherein the single common trigger is further indicative of a length of the discovery resource pattern.

14. The method of claim 10 wherein the resources used for transmitting the multiple transmission instances of the discovery signal are defined by a discovery resource pattern.

15. The method of claim 14 wherein the discovery resource pattern is assigned to the wireless device by the controlling node.

16. The method of claim 14 wherein the discovery resource pattern is wireless device specific.

17. The method of claim 14 wherein the discovery resource pattern is cell-specific.

18. The method of claim 14 wherein the discovery resource pattern is signaled from the controlling node to the wireless device.

19. The method of claim 14 wherein the discovery resource pattern is predefined.

20. The method of claim 14 wherein the discovery resource pattern is assigned to multiple wireless devices, including the wireless device, such that a monitoring wireless device is enabled to monitor for discovery signals for all wireless devices under the control of the same controlling node at least once within a length of a period of the discovery resource pattern.

21. The method of claim 14 wherein the multiple transmission instances of the discovery signal cover at least a full cycle of the discovery resource pattern.

22. A wireless device enabling Device-to-Device, D2D, discovery, comprising:
a transceiver;
at least one processor; and
memory containing software executable by the at least one processor whereby the wireless device is operative to:
receive, via the transceiver, at least one trigger for D2D discovery from a controlling node of the wireless device in a cellular communications network; and
transmit, via the transceiver, multiple transmission instances of a discovery signal of the wireless device for a D2D discovery event in response to the at least one trigger using resources selected from a group consisting of: different time resources, different frequency resources, different code resources, different time and frequency resources, different time and code resources, different frequency and code resources, and different time, frequency, and code resources.

23. A method of operation of a network node of a cellular communications network to trigger Device-to-Device, D2D, discovery, comprising:
transmitting at least one trigger for D2D discovery to a wireless device in the cellular communications network;
wherein the at least one trigger causes the wireless device to transmit multiple instances of a discovery signal for a D2D discovery event using resources selected from a group consisting of: different time resources, different frequency resources, different code resources, different time and frequency resources, different time and code resources, different frequency and code resources, and different time, frequency, and code resources.

24. The method of claim 23 wherein the at least one trigger causes the wireless device to transmit the multiple instances of the discovery signal using different time resources.

25. The method of claim 23 wherein the at least one trigger causes the wireless device to transmit the multiple instances of the discovery signal using different frequency resources.

26. The method of claim 23 wherein the at least one trigger causes the wireless device to transmit the multiple instances of the discovery signal using different code resources.

27. The method of claim 23 wherein the at least one trigger causes the wireless device to transmit the multiple instances of the discovery signal using different time and frequency resources.

28. The method of claim 23 wherein the at least one trigger causes the wireless device to transmit the multiple instances of the discovery signal using different time and code resources.

29. The method of claim 23 wherein the at least one trigger causes the wireless device to transmit the multiple instances of the discovery signal using different frequency and code resources.

30. The method of claim 23 wherein the at least one trigger causes the wireless device to transmit the multiple instances of the discovery signal using different time, frequency, and code resources.

31. The method of claim 23 wherein transmitting the at least one trigger comprises transmitting an individual trigger for each of the multiple transmission instances of the discovery signal.

32. The method of claim 23 wherein transmitting the at least one trigger comprises transmitting a single common trigger for all of the multiple transmission instances of the discovery signal.

33. The method of claim 32 wherein the single common trigger indicates a discovery resource pattern for the multiple transmission instances of the discovery signal, the discovery resource pattern being indicative of a set of resources comprising the resources used by the wireless device to transmit the multiple instances of the discovery signal for the D2D discovery event.

34. The method of claim 33 wherein the single common trigger is further indicative of a length of the discovery resource pattern.

35. The method of claim 33 wherein the discovery resource pattern is assigned to the wireless device.

36. The method of claim 33 wherein the discovery resource pattern is wireless device specific.

37. The method of claim 33 wherein the discovery resource pattern is cell-specific.

38. The method of claim 33 wherein the discovery resource pattern is signaled to the wireless device.

39. The method of claim 33 wherein the discovery resource pattern is predefined.

40. The method of claim 33 wherein the discovery resource pattern is assigned to multiple wireless devices, including the wireless device, such that a monitoring wireless device is enabled to monitor for discovery signals for all wireless devices under the control of the same controlling node at least once within a length of a period of the discovery resource pattern.

41. The method of claim 33 wherein the multiple transmission instances of the discovery signal cover at least a full cycle of the discovery resource pattern.

42. A network node of a cellular communications network, comprising:
a radio unit;
at least one processor; and
memory containing software executable by the at least one processor whereby the network node is operative to transmit, via the radio unit, at least one trigger for Device-to-Device, D2D, discovery to a wireless device in the cellular communications network;
wherein the at least one trigger causes the wireless device to transmit multiple instances of a discovery signal for a D2D discovery event using resources selected from a group consisting of: different time resources, different frequency resources, different code resources, different time and frequency resources, different time and code resources, different frequency and code resources, and different time, frequency, and code resources.
